(19) United States
(12) Patent Application Publication
(10) Pub. No.: US 2026/0197438 A1
(43) Pub. Date: Jul. 9, 2026

(54) APPLICATIONS OF CHAINED MOTION VECTOR PREDICTION FOR ADVANCED MOTION VECTOR PREDICTION AND SUBBLOCK MODES

(71) Applicant: Alibaba (China) Co., Ltd., Hangzhou (CN)

(72) Inventors: Chen Li, Hangzhou (CN); Ru-ling Liao, Sunnyvale, CA (US); Jie Chen, Beijing (CN); Yan Ye, San Diego, CA (US)

(21) Appl. No.: 19/436,761

(22) Filed: Dec. 30, 2025

Related U.S. Application Data
(60) Provisional application No. 63/742,404, filed on Jan. 6, 2025.
(60) Provisional application No. 63/773,963, filed on Mar. 18, 2025.

(51) Int. Cl. H04N 19/105; H04N 19/176; H04N 19/513

(52) U.S. Cl. CPC H04N 19/105; H04N 19/176; H04N 19/513

(57) ABSTRACT

Methods and systems implement application of chained motion vector prediction (“CMVP”). A VVC and later standard encoder and a VVC and later standard decoder, and/or an AVS3 and later-standard encoder and an AVS3 and later-standard decoder, can configure one or more processors of a computing system to apply CMVP in conjunction with Advanced Motion Vector Prediction (“AMVP”) mode while constructing spatially neighboring MVP candidates; apply CMVP in conjunction with Affine merge mode when inheriting Affine candidates; and apply CMVP in conjunction with subblock-based temporal motion vector prediction (“SbTMVP”) to obtain new motion shifts.

### RELATED APPLICATIONS

This application claims the benefit of U.S. Patent Application No. 63/742,404, entitled “APPLICATIONS OF CHAINED MOTION VECTOR PREDICTION FOR ADVANCED MOTION VECTOR PREDICTION AND SUBBLOCK MODES” and filed Jan. 6, 2025, and U.S. Patent Application No. 63/773,963, entitled “APPLICATIONS OF CHAINED MOTION VECTOR PREDICTION FOR ADVANCED MOTION VECTOR PREDICTION AND SUBBLOCK MODES” and filed Mar. 18, 2025, which are expressly incorporated herein by reference in their entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET developed further techniques beyond the scope of the VVC standard under the Enhanced Compression Model (“ECM”) name, which has formed the basis for the successor H.267 standard currently in draft status.

According to VVC and later standards, an encoder and a decoder perform inter-picture prediction by motion vectors (“MVs”). After the motion vector of a subblock is derived, motion compensation interpolation filters are applied to generate a predictor of each subblock based on the derived motion vector, and motion compensation interpolation filters are applied to generate a predictor of each subblock based on the derived motion vector. As done for translational motion inter prediction, there are also two affine motion inter prediction modes: affine merge mode and affine Advanced Motion Vector Prediction (“AMVP”) mode.

Moreover, at time of writing, the latest draft of ECM (presented at the 40th meeting of the JVET in October 2025 as “Algorithm description of Enhanced Compression Model 19 (ECM 19)”) includes proposals to further implement chained motion vector prediction (“CMVP”) candidates, which are derived with accumulation of recursively traced MVs and block vectors based on the pre-derived MVs.

There is a need to further improve affine merge mode and affine AMVP mode.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, an encoding process and a decoding process according to an example embodiment of the present disclosure.

FIGS. 2A and 2B illustrate diagrams of the affine motion field of a block with, respectively, four parameters (two control points) and six parameters (three control points). While in the real world there are many kinds of motion (e.g., zoom), according to VVC and later standards, a block-based affine transform motion compensation prediction is applied.

FIG. 3 illustrates a diagram of affine motion vectors of luma subblocks calculated for each subblock center sample.

FIG. 4A illustrates SbTVMP implemented according to VVC and later standards.

FIG. 4B illustrates a motion shift which is derived using the motion vector of the bottom-left neighboring blocks of the current block.

FIG. 5 illustrates application of CMVP to Advanced Motion Vector Prediction (“AMVP”) according to example embodiments of the present disclosure.

FIG. 6 illustrates derivation of CMVP candidates according to example embodiments of the present disclosure.

FIG. 7 illustrates an affine candidate list and the order of all candidate types.

FIG. 8 illustrates constructing affine CMVP candidates by inheriting the affine parameters of temporal reference coded blocks.

FIG. 9 illustrates application of CMVP in affine AMVP mode.

FIG. 10 illustrates deriving new CMVP candidates for subblock-based temporal motion vector prediction (“SbTMVP”) according to example embodiments of the present disclosure.

FIG. 11 illustrates application of CMVP in conjunction with SbTMVP according to ECM.

FIG. 12 illustrates an example system for implementing the processes and methods described herein for implementing chained motion vector prediction.

### DETAILED DESCRIPTION

Systems and methods discussed herein are directed to implementing chained motion vector prediction (“CMVP”), and more specifically application of CMVP to Advanced Motion Vector Prediction (“AMVP”) and Affine merge modes, and application of CMVP to the motion shift of subblock-based temporal motion vector prediction (“SbTMVP”).

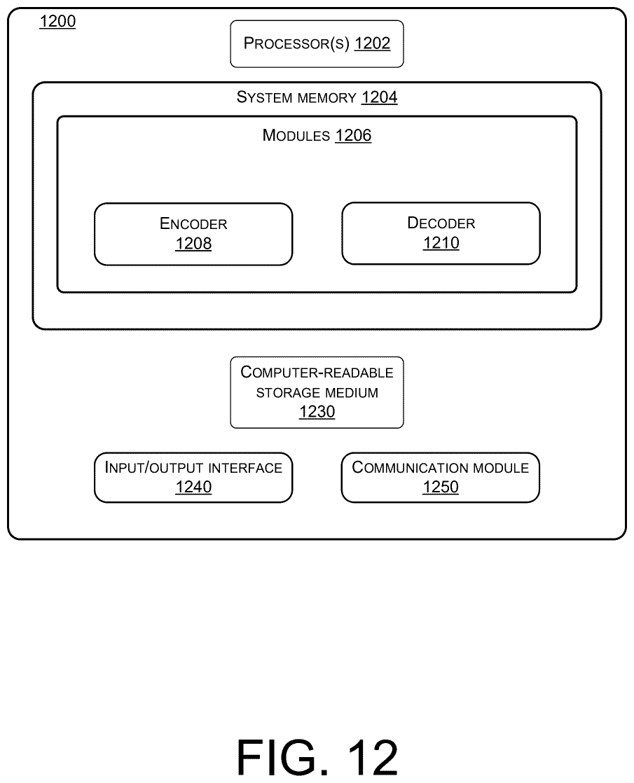

In accordance with the VVC video coding standard and successor standards currently in draft status such as H.267 (“VVC and later standards”) and motion prediction as described therein, a computing system includes at least one or more processors and a computer-readable storage medium communicatively coupled to the one or more processors. The computer-readable storage medium is a non-transient or non-transitory computer-readable storage medium, as defined subsequently with reference to FIG. 12, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by VVC and later standards, and operations of a decoder as described by VVC and later standards. Some of these encoder operations and decoder operations according to VVC and later standards are subsequently described in further detail, though these subsequent descriptions should not be understood as exhaustive of encoder operations and decoder operations according to VVC and later standards. Subsequently, a “VVC and later standard encoder” and a “VVC and later standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC and later standard encoder and a VVC and later standard decoder further include computer-readable instructions stored on a computer-readable storage medium which are executable by one or more processors of a computing system to configure the one or more processors to perform operations not specified by VVC and later standards. A VVC and later standard encoder should not be understood as limited to operations of a reference implementation of an encoder, but including further computer-readable instructions configuring one or more processors of a computing system to perform further operations as described herein. A VVC and later standard decoder should not be understood as limited to operations of a reference implementation of a decoder, but including further computer-readable instructions configuring one or more processors of a computing system to perform further operations as described herein.

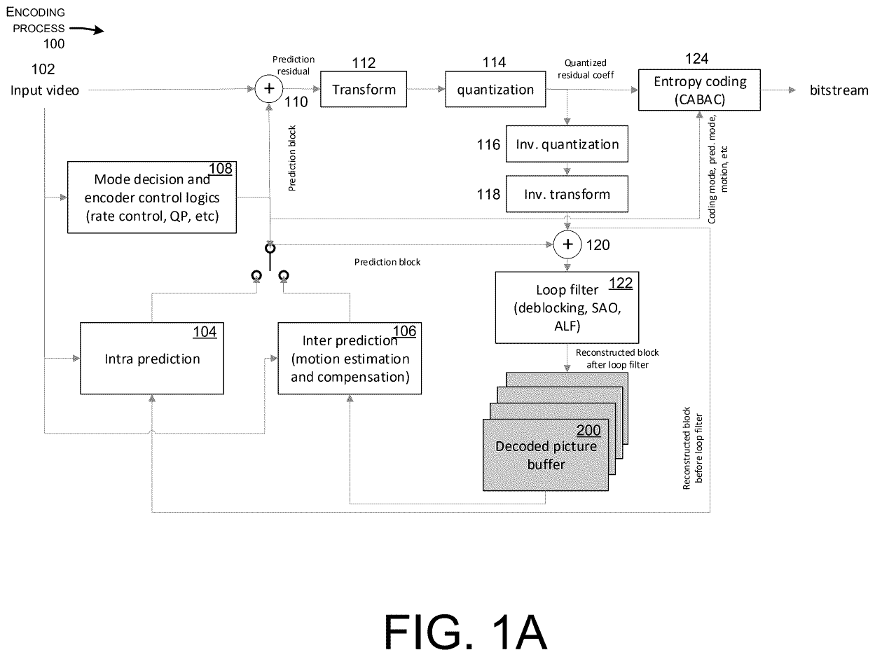

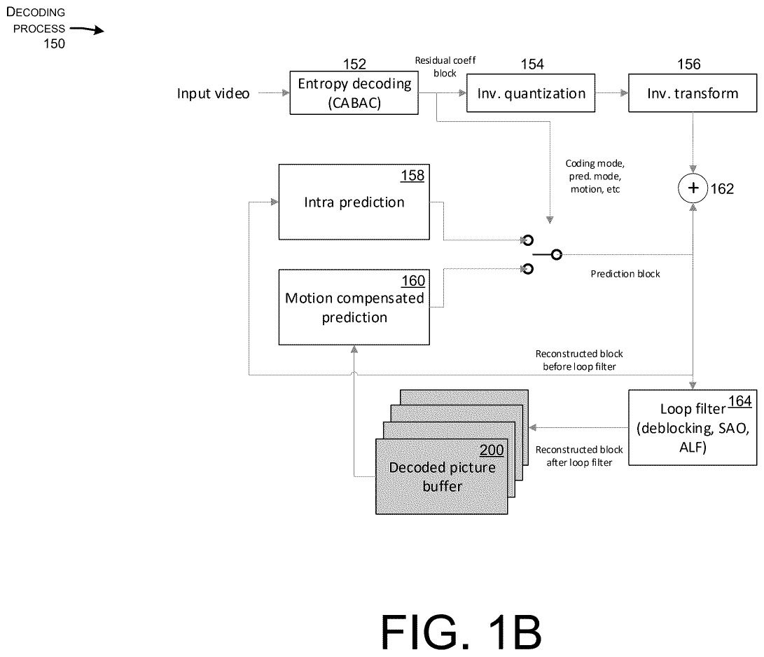

FIGS. 1A and 1B illustrate example block diagrams of, respectively, an encoding process 100 and a decoding process 150 according to an example embodiment of the present disclosure.

In an encoding process 100, a VVC and later standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC and later standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC and later standard encoder encodes a picture (a picture being encoded being called a “current picture,” as distinguished from any other picture received from an image source 102) by configuring one or more processors of a computing system to partition the original picture into units and subunits according to a partitioning structure. A VVC and later standard encoder configures one or more processors of a computing system to subdivide a picture into macroblocks (“MBs”) each having dimensions of 16×16 pixels, which may be further subdivided into partitions. A VVC and later standard encoder configures one or more processors of a computing system to subdivide a picture into coding tree units (“CTUs”), the luma and chroma components of which may be further subdivided into coding tree blocks (“CTBs”) which are further subdivided into coding units (“CUs”). Alternatively, a VVC and later standard encoder configures one or more processors of a computing system subdivide a picture into units of N×N pixels, which may then be further subdivided into subunits. Each of these largest subdivided units of a picture may generally be referred to as a “block” for the purpose of this disclosure.

A CU is coded using one block of luma samples and two corresponding blocks of chroma samples, where pictures are not monochrome and are coded using one coding tree.

A VVC and later standard encoder configures one or more processors of a computing system to subdivide a block into partitions having dimensions in multiples of 4×4 pixels. For example, a partition of a block may have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC and later standard encoder configures one or more processors of a computing system to encode color information of a picture at a lower resolution than the input picture, storing the color information in fewer bits than the input picture.

Furthermore, a VVC and later standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs may refer to a unit or multiple subunits corresponding to a block structure among multiple block structures of a picture, such as an MB or a CTU, wherein blocks are partitioned based on the picture data and are coded according to VVC and later standards. Motion information corresponding to a PU may describe motion prediction as encoded by a VVC and later standard encoder as described herein.

A VVC and later standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction may further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC and later standard encoder configures one or more processors of a computing system to code a CU to include reference indices to identify, for reference of a VVC and later standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC and later standard encoder configures one or more processors of a computing system to code each current block of a picture individually, outputting a prediction block for each. According to VVC and later standards, a CTU can be as large as 128×128 luma samples (plus the corresponding chroma samples, depending on the chroma format). A CTU may be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

According to intra prediction, the CU is predicted using spatially neighboring samples with 67 intra prediction modes (DC mode, planar mode, or 65 angular modes), cross-component linear model prediction, multiple reference line intra prediction, intra sub-partitions or matrix weighted intra prediction modes. According to inter prediction, the CU is predicted using samples of reference pictures with merge mode, merge mode with motion vector difference (MMVD), geometric partition mode (GPM), combined inter and intra prediction (CIIP), bi-prediction with CU-level weight (BCW), adaptive motion vector resolution, affine motion compensation prediction, subblock-based temporal motion vector prediction, bi-directional optical flow, decoder-side motion vector refinement or symmetric motion vector difference coding modes.

After a prediction block is output, a VVC and later standard encoder configures one or more processors of a computing system to send coding parameter sets such as coding mode (i.e., intra or inter prediction), a mode of intra prediction or a mode of inter prediction, and motion information to an entropy coder 124 (as described subsequently).

VVC and later standards provide semantics for recording coding parameter sets for a CU. For example, with regard to the above-mentioned coding parameter sets, pred_mode_flag for a CU is set to 0 for an inter-coded block, and is set to 1 for an intra-coded block; general merge flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that VVC and later standards includes semantics for recording various other information, flags, and options which are beyond the scope of the present disclosure.

A VVC and later standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC and later standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

After either intra or inter prediction, residues are transformed and quantized.

Based on a prediction residual, a VVC and later standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients may refer to coefficients representing one of several spatial transformations, such as a diagonal flip, a vertical flip, or a rotation, which may be applied to a sub-block.

According to VVC and later standards, multiple transform cores including discrete cosine transform (“DCT”)-II, DCT-VIII and discrete sine transform (“DST”)-VII are supported. Additional transforms supported include larger block-size transform with zero-out for high frequency components, and subblock transform.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC and later standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC and later standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded. Dependent quantization and joint coding of chroma residuals are implemented in VVC and later standards.

A VVC and later standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC and later standard encoder further implements an adder 120. One or more processors of a computing system are configured to perform an addition operation by adding a prediction block and a reconstructed residual, outputting a reconstructed block.

A VVC and later standard encoder further implements a loop filter 122. One or more processors of a computing system are configured to apply a loop filter, such as a deblocking filter, a sample adaptive offset (“SAO”) filter, adaptive loop filter (“ALF”), and/or luma mapping with chroma scaling, to a reconstructed block, outputting a filtered reconstructed block.

A VVC and later standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC and later standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC and later standard encoder configures one or more processors of a computing system to output a coded picture, made up of coded blocks from the entropy coder 124. The coded picture is output to a transmission buffer, where it is ultimately packed into a bitstream for output from the VVC and later standard encoder. The bitstream is written by one or more processors of a computing system to a non-transient or non-transitory computer-readable storage medium of the computing system, for transmission.

In a decoding process 150, a VVC and later standard decoder configures one or more processors of a computing system to receive, as input, one or more coded pictures from a bitstream.

A VVC and later standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC and later standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC and later standard decoder determines whether to apply intra prediction 158 (i.e., spatial prediction) or to apply motion compensated prediction 160 (i.e., temporal prediction) to the reconstructed residual.

In the event that the coding parameter sets specify intra prediction, the VVC and later standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC and later standard decoder configures one or more processors of a computing system to perform motion compensated prediction 160 using a reference picture from a DPB 200. The motion compensated prediction 160 thereby generates a prediction signal.

A VVC and later standard decoder further implements an adder 162. The adder 162 configures one or more processors of a computing system to perform an addition operation on the reconstructed residuals and the prediction signal, thereby outputting a reconstructed block.

A VVC and later standard decoder further implements a loop filter 164. One or more processors of a computing system are configured to apply a loop filter, such as a deblocking filter, a SAO filter, and ALF to a reconstructed block, outputting a filtered reconstructed block.

A VVC and later standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC and later standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC and later standard encoder and a VVC and later standard decoder each implements motion prediction coding in accordance with the VVC specification. A VVC and later standard encoder and a VVC and later standard decoder each configures one or more processors of a computing system to generate a reconstructed picture based on a previous reconstructed picture of a DPB according to motion compensated prediction as described by VVC and later standards, wherein the previous reconstructed picture serves as a reference picture in motion compensated prediction as described herein.

After the motion vector of a subblock is derived, motion compensation interpolation filters are applied to generate a predictor of each subblock based on the derived motion vector. HEVC replaced the approach of implicitly deriving the motion vector predictor (“MVP”) by implementing motion vector competition, wherein motion vector derivation is based on explicitly signaling MVPs from a list of MVPs. A variable coding quadtree block structure provided by HEVC can result in one block having several neighboring blocks with motion vectors as potential MVP candidates. To account for such flexible block structures, motion vector competition was further modified by implementing Advanced Motion Vector Prediction (“AMVP”).

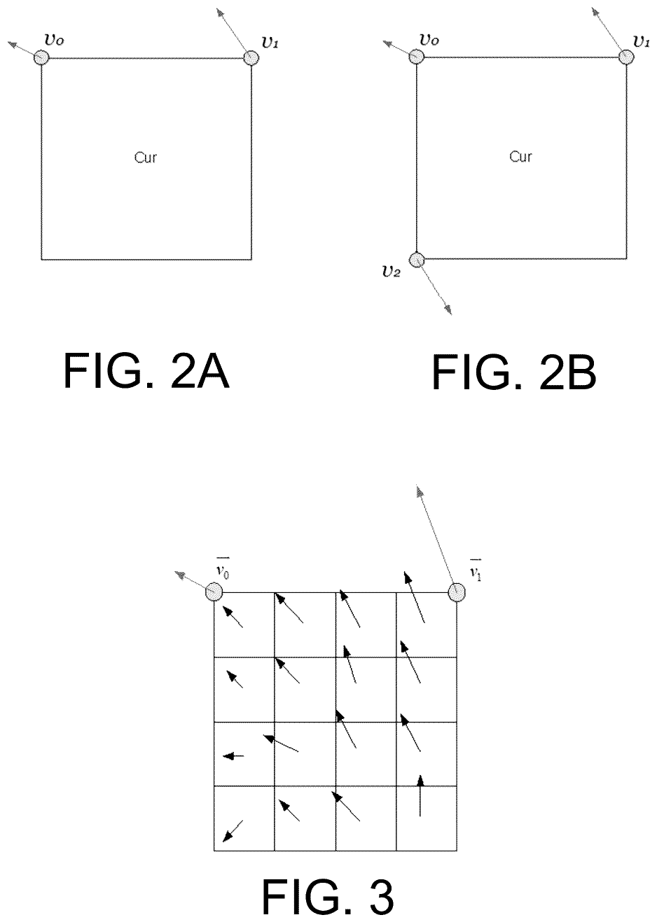

According to HEVC, only a translation motion model is applied for motion compensation prediction (“MCP”). In real-world video content, however, many kinds of motion occur, such as zooming in/out, rotation, perspective changes, and other irregular motions. According to VVC and later standards, a block-based affine transform motion compensation prediction is applied. As shown in FIGS. 2A and 2B, the affine motion field of a block is described by motion information of two control point motion vectors (a 4-parameter affine motion model, as illustrated in FIG. 2A) or three control point motion vectors (a 6-parameter affine motion model, as illustrated in FIG. 2B).

In affine motion compensation, for a 4-parameter affine motion model, the motion vector at sample location (x, y) in a block is derived according to Equation 1 below:

$$\{ \begin{matrix}m {ν}_{x} = \frac{m {ν}_{1 x} - m {ν}_{0 x}}{W} x + \frac{m {ν}_{0 y} - m {ν}_{1 y}}{W} y + m {ν}_{0 x} \\ m {ν}_{y} = \frac{m {ν}_{1 y} - m {ν}_{0 y}}{W} x + \frac{m {ν}_{1 x} - m {ν}_{0 x}}{W} y + m {ν}_{0 y}\end{matrix}$$

For a 6-parameter affine motion model, the motion vector at a sample location (x, y) in a block is derived according to Equation 2 below:

$$\{ \begin{matrix}m {ν}_{x} = \frac{m {ν}_{1 x} - m {ν}_{0 x}}{W} x + \frac{m {ν}_{2 x} - m {ν}_{0 x}}{H} y + m {ν}_{0 x} \\ m {ν}_{y} = \frac{m {ν}_{1 y} - m {ν}_{0 y}}{W} x + \frac{m {ν}_{2 y} - m {ν}_{0 y}}{H} y + m {ν}_{0 y}\end{matrix}$$

where (mv₀ₓ, mv_{0y}) is a motion vector of the top-left corner control point, (mv₁ₓ, mv_{1y}) is a motion vector of the top-right corner control point, and (mv₂ₓ, mv_{2y}) is a motion vector of the bottom-left corner control point.

To simplify motion compensation prediction, block-based affine transform prediction is applied. To derive a motion vector of each 4×4 luma subblock, the motion vector of the center sample of each subblock, as shown in FIG. 3, is calculated according to the above Equation 1 and Equation 2, and rounded to 1/16 fraction accuracy. FIG. 3 illustrates a diagram of affine motion vectors of luma subblocks calculated for each subblock center sample.

After the motion vector of a subblock is derived, motion compensation interpolation filters are applied to generate a predictor of each subblock based on the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

VVC and later standards further implement subblock-based temporal motion vector prediction (“SbTMVP”). In SbTMVP mode, similar to temporal motion vector prediction (“TMVP”) provided by HEVC, a coding block is split into 4×4 subblocks and each subblock obtains its own motion vector from the motion field in the collocated picture, improving motion vector prediction and merge mode for CUs in the current picture. The collocated picture is a reference picture which was already encoded or decoded, and the same collocated picture according to TMVP is used for SbTVMP.

Contrary to TMVP implementations, where motion is predicted at CU-level, motion prediction is at sub-CU level according to SbTMVP.

Furthermore, contrary to TMVP implementations, where temporal motion vectors are fetched from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatially neighboring blocks of the current CU.

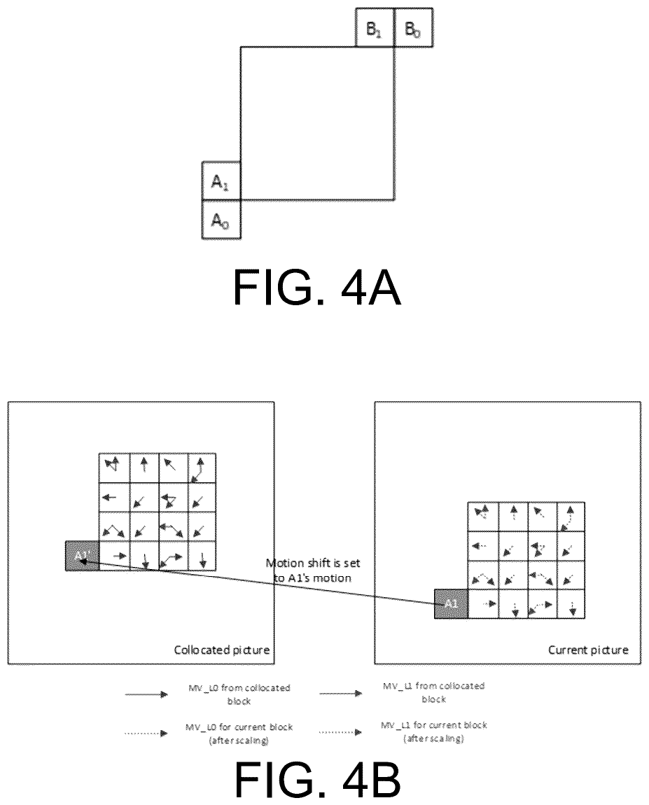

When obtaining motion vector for each subblock, a motion shift which is derived using the motion vector of the bottom-left neighboring blocks of the current block is applied. As depicted in FIG. 4B, the motion shift MVAI is obtained from its neighboring block A1 and is used to derive the motion field in the collocated picture. Then, for each subblock, the motion information of its corresponding subblock in the collocated picture is used to derive the motion information of the subblock.

FIG. 4A illustrates SbTVMP implemented according to VVC and later standards. Motion vectors of the sub-CUs within the current CU are predicted in two steps: in the first step, if the spatial neighbor A1 in FIG. 4A has a motion vector that uses the collocated picture as its reference picture, this motion vector is selected to be the motion shift to be applied. If no such motion is identified, then the motion shift is set to (0, 0).

In the second step, the motion shift identified in the first step is applied (i.e., added to the current block's coordinates) to obtain sub-CU-level motion information (motion vectors and reference indices) from the collocated picture as illustrated in FIG. 4B. The example of FIG. 4B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to motion vectors and reference indices of the current sub-CU in a similar fashion as the TMVP process of HEVC, where temporal motion scaling is applied to align the reference pictures of the temporal motion vectors to those of the current CU.

ECM further provides a combined subblock-based merge list which contains both SbTVMP candidate and affine merge candidates, used for signaling of subblock-based merge mode. SbTVMP mode is enabled or disabled by signaling a SPS flag. If SbTMVP mode is enabled, the SbTMVP predictor is added as the first entry of the list of subblock-based merge candidates, and followed by the affine merge candidates. The size of a subblock-based merge list is signaled in an SPS flag, and the maximum allowed size of the subblock-based merge list is 5 as provided by ECM.

The sub-CU size used in SbTMVP is fixed to 8×8, and as done for affine merge mode, SbTMVP mode is only applicable to CUs with both width and height larger than or equal to 8.

The encoding logic of the additional SbTMVP merge candidate is the same as for the other merge candidates: that is, for each CU in P or B slice, an additional RD check is performed to decide whether to use the SbTMVP candidate.

Chained motion vector prediction (“CMVP”) candidates are introduced as merge candidates, and are inserted after history motion vector prediction (“HMVP”) candidates for regular merge and TM merge modes. Similar to auto-relocated block vector (“BV”) prediction, CMVP candidates are derived as the accumulation of the recursively traced MVs and BVs based on the pre-derived MVs. CMVP candidates can be derived for each merge index and each reference picture list. The traceable reference pictures are restricted to the reference pictures in the reference picture list.

Additional CMVP candidates are added just before the zero padding candidates in the initial merge candidate list. The maximum size of the initial merge candidate list is increased by 4, while the maximum number of the candidates before the original CMVP candidates is kept unchanged.

When deriving the additional CMVP candidates, only the center position of the current block is checked to find traced MVs or BVs.

TMVP candidates with MV scaled to reference picture with index 0 are added if the existed TMVP candidates has non-zero reference index. The additional TMVP candidates are used to derive CMVP candidates. After TMVP and the related CMVP candidates are derived, ARMC reordering is performed. CMVP candidates are derived in block matching (“BM”) merge mode as well.

Additional candidates are added by combining the source MV with CMVP. The source MV is the MV used to derive CMVP, which is a uni-directional MV. For example, if the source MV comes from the reference picture list 0, the list 0 MV of the CMVP is replaced by this MV and the result is used as a new combined candidate in subblock candidate list.

The above-mentioned derivation of CMVP candidates is only applied to regular merge mode and subblock-level SbTMVP, but not to AMVP, Affine merge, or Affine AMVP. According to the present ECM proposals, AMVP, Affine merge, and Affine AMVP modes cannot benefit from CMVP.

Therefore, example embodiments of the present disclosure implement application of CMVP to AMVP, Affine merge, and Affine AMVP, providing a greater number of motion vector predictions. Example embodiments of the present disclosure further implement application of CMVP to the motion shift of SbTMVP.

According to an example embodiment of the present disclosure, CMVP is employed in conjunction with AMVP mode while constructing spatially neighboring MVP candidates. The MVs at neighboring positions are initially used to derive CMVP candidates. Subsequently, the CMVP candidates are scaled to the pre-defined reference picture, thereby replacing the spatial candidates of the original MVPs.

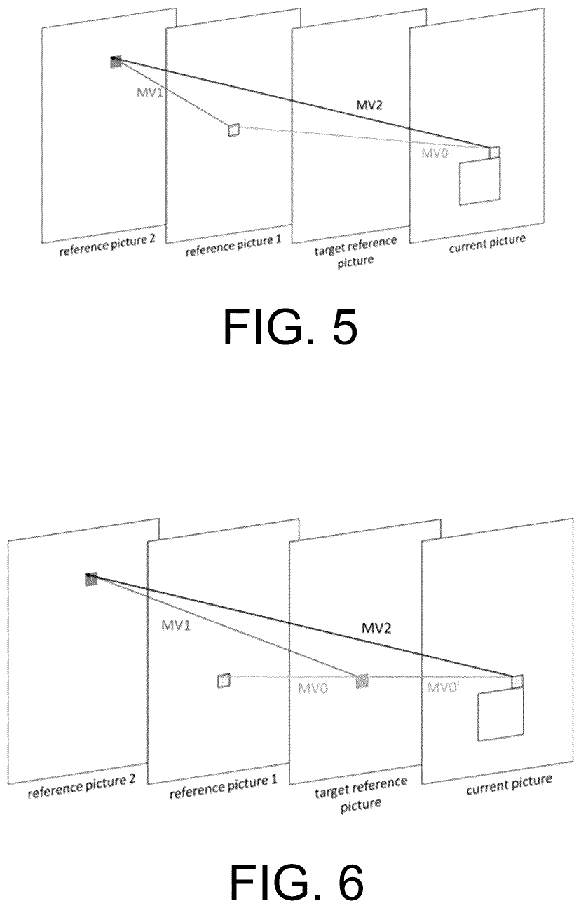

FIG. 5 illustrates application of CMVP to AMVP according to example embodiments of the present disclosure. MV0 is the motion vector which points to reference picture 1 of a top neighboring block. MV1 is the motion of the reference block of the top neighboring block, and MV1 is pointed to reference picture 2. According to ECM, MV0 is used to derive an AMVP candidate and is scaled to the target reference picture. In contrast, according to example embodiments, CMVP is applied: MV2 (which is equivalent to MV0 plus MV1) is used to derive AMVP candidate and is scaled to the target reference picture.

According to another example embodiment of the present disclosure, CMVP candidates are derived as illustrated by FIG. 6. MV0′ is a spatial MV implemented according to an ECM encoder and decoder, which is obtained by scaling MV0 to the target reference picture as described above. MV1 is the motion of the reference block of the top neighboring block pointed by MV0′. Compared with the method of FIG. 5, MV0′ is utilized to derive a CMVP, denoted as MV2 (which is equivalent to MV0′ plus MV1). MV2 is then used to derive AMVP candidate and is scaled to the target reference picture.

According to another example embodiment of the present disclosure, the TMVP of AMVP mode can be used to derive temporal CMVP candidates as illustrated by FIG. 6. Furthermore, MVs at non-adjacent CMVPs using the method illustrated in either the first or the second embodiment which are depicted in FIG. 5 and FIG. 6. Additionally, the HMVP of AMVP mode can also be used to derive historical positions can also be used to derive non-adjacent CMVP candidates using the method illustrated in either the first or the second embodiment which are depicted in FIG. 5 and FIG. 6. The resultant CMVP candidates substitute for the original TMVP, HMVP and non-adjacent candidates.

According to another example embodiment of the present disclosure, new CMVP candidates illustrated in the above embodiments are added as additional candidates in the original MVP list, including the temporal and historical CMVP candidates derived by the second method depicted in FIG. 6, the spatial and non-adjacent CMVP candidates derived by both the two methods. A maximum of N additional CMVP candidates are incorporated, wherein N is a positive integer. For example, N is set equal to 2.

The aforementioned embodiments can be combined freely. It is important to note that the maximum number of additional CMVP candidates for AMVP is M, including spatial, temporal, non-adjacent and history CMVP candidates, wherein M is a positive integer. For example, M is set equal to 2.

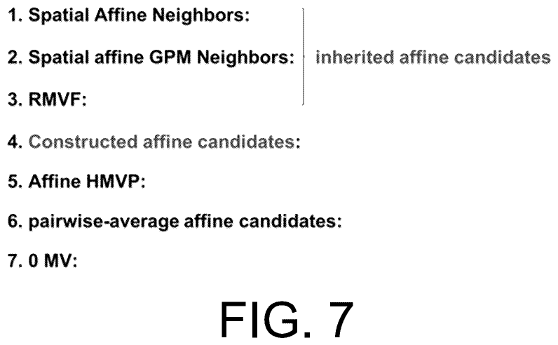

According to an example embodiment of the present disclosure, CMVP is applied to Affine merge mode when inheriting Affine candidates. CMVP candidates of a pre-constructed affine list are then used to derive the MV of the central subblock. The MV is used to trace an MV offset, defined as the translation component of the traced CU when the traced CU uses affine motion compensation. Otherwise, the MV of the traced subblock is regarded as the MV offset. The MV offset is then accumulated to the original CMVP candidates. A maximum of N additional affine CMVP candidates are added after the inherited affine candidates and before the constructed affine candidates, wherein N is a positive integer. FIG. 7 illustrates an affine candidate list and the order of all candidate types: according to the present embodiment, CMVP candidates are added between the third and fourth type of candidate of FIG. 7.

According to another example embodiment of the present disclosure, the affine CMVP candidates illustrated in the above embodiment are added after the constructed affine candidates. According to the present embodiment, CMVP candidates are added after the fourth type of candidate of FIG. 7.

According to another example embodiment of the present disclosure, CMVP is applied in constructing affine candidates in the context of Affine merge mode. The top-left, top-right and bottom-left neighboring MVs are used to derive CMVP candidates, while the bottom-right MV is used to construct TMVP candidates, in accordance with an ECM encoder and decoder. The four MVs are combined into affine candidates, in accordance with an ECM encoder and decoder. The additional affine candidates are located after the constructed affine candidates as shown in FIG. 7. A maximum of N additional CMVP candidates are incorporated, wherein the N is a positive integer. For example, N is set equal to 2.

According to another example embodiment of the present disclosure, the bottom-right MV is replaced by a chained TMVP.

According to another example embodiment of the present disclosure, CMVP is applied in constructing non-adjacent affine candidates in the context of Affine merge mode. The non-adjacent MVs, specifically the top-left, top-right, and bottom-left, are used to derive CMVP candidates. The three MVs are combined into affine candidates in accordance with an ECM encoder and decoder.

The above-mentioned embodiments wherein CMVP is applied in constructing affine candidates in the context of Affine merge mode can be combined freely. The maximum number of additional CMVP candidates for constructed affine candidates is M, including adjacent and non-adjacent constructed affine candidates, wherein M is a positive integer. For example, M is set equal to 2.

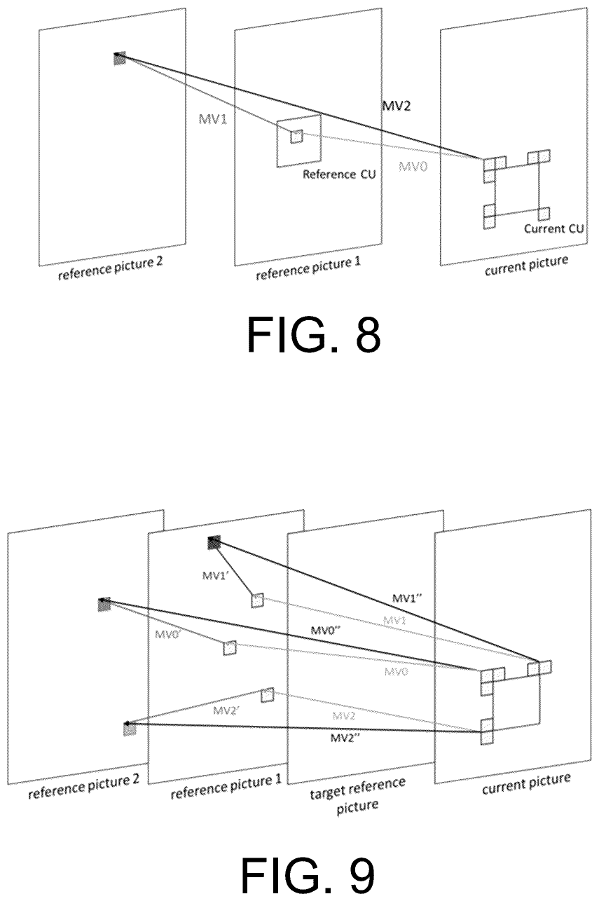

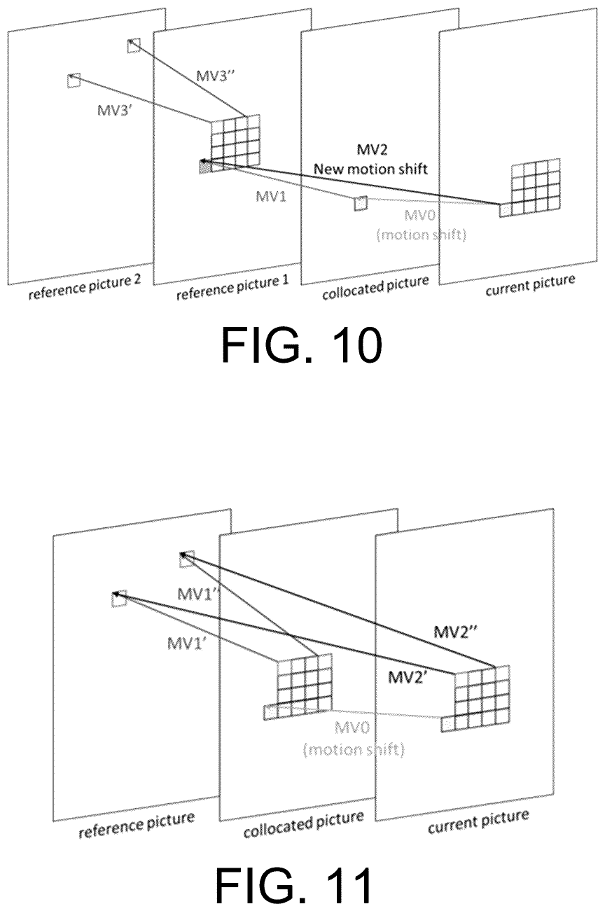

According to another example embodiment of the present disclosure, the affine CMVP candidates are constructed by inheriting the affine parameters of temporal reference coded blocks. As illustrated in FIG. 8, motion vectors of seven adjacent neighbor positions and the bottom-right positions (TMVP) of the current CU are used to search a reference CU in reference picture 1. If the reference CU is coded with affine motion compensation, the affine parameters of the reference CU are inherited. As illustrated, MV0 is the motion vector which points to reference picture 1 of top neighboring block, MV1 is the motion of the reference block of the top neighboring block, and MV1 is pointed to reference picture 2. The affine parameters (a, b, c, d) of reference CU in the reference picture 1 are inherited and the MV2 (which is equivalent to MV0 plus MV1) is used as the base MV (mv_{base}). The new affine candidates are derived according to Equation 3 as follows.

$$\{ \begin{matrix}{mv}^{h} ( x , y ) = a ( x - {x}_{base} ) + c ( y - {y}_{base} ) + m {v}_{base}^{h} \\ {mv}^{v} ( x , y ) = b ( x - {x}_{base} ) + d ( y - {y}_{base} ) + m {v}_{base}^{v}\end{matrix}$$

In addition, the motion vector of non-adjacent neighbor positions of the current CU are also considered for the purpose of deriving new affine candidates. A maximum of N additional CMVP candidates are incorporated, where N is a positive integer number. For example, N is set equal to 2.

The above-mentioned implementations of CMVP in the context of affine merge can be integrated into affine BM merge mode.

According to another example embodiment, CMVP is incorporated into the affine AMVP mode. In this mode, the three CPMVs are constructed based on the motion vectors of the top left, top right and bottom left neighbor positions of the current block. As illustrated in FIG. 9, the motion vectors of adjacent neighbor positions (MV0, MV1 and MV2) are used to derive chained motion vectors (MV0″, MV1″ and MV2″) as described above with reference to FIG. 5. The three chained motion vectors are then coalesced to constitute an affine candidate.

According to another example embodiment, CMVP derivation for each CPMV is performed as described above with reference to FIG. 6.

According to an example embodiment of the present disclosure, CMVP is applied to SbTMVP. New motion shifts are obtained by tracing CMVP on the original motion shifts, which are located in collocated pictures, and the new motion shifts are used to derive additional subblock MVs.

FIG. 8 illustrates deriving new CMVP candidates for SbTMVP according to example embodiments of the present disclosure. MV0 is the original motion shift (which is the motion of the bottom-left neighbor of the current CU and pointed to the collocated picture) and MV1 is the motion of the reference block of the bottom-left neighboring subblock. MV2 is utilized as a new motion shift to derive MVs for each subblock by scaling MV3′, MV3″ . . . in accordance with ECM. Unlike the existing CMVP extension for SbTMVP implemented according to ECM, which is illustrated in FIG. 9, the present method derives subblock-level CMVP by directly accumulating motion shift (MV0) and the motion of subblock in collocated picture (MV1′, MV1″ . . . ). The accumulated motion vector MV2′, MV2″ . . . are the final subblock motion of the current block. The newly derived subblock candidates are appended to the existing subblock candidates and a maximum of N additional CMVP candidates are incorporated, wherein N is a positive integer.

According to another example embodiment of the present disclosure, the constraint of collocated pictures for motion shifts in the above embodiment is removed, and the new motion shifts are obtained by tracing CMVP upon the original motion shifts.

The aforementioned embodiments can be combined freely.

In 2016, the Audio Video coding Standard (“AVS”) workgroup published the AVS2 standard for digital audio and video series compression. This standard further improves video coding performance over prior standards such as AVS1, H.264/AVC (Advanced Video Coding) and H.265/HEVC (High Efficiency Video Coding). The AVS continues to propose additional improvements to a third generation of AVS standard, collected under the AVS3 name. Presently, the AVS workgroup is reviewing draft proposals for subsequent improvements over AVS3 techniques to be included in the successor AVS4 standard. The example embodiments herein of applying the updated merge syntax structure can also be applied to merge mode in AVS3 and later standards.

FIG. 12 illustrates an example system 1200 for implementing the processes and methods described above for implementing chained motion vector prediction.

The techniques and mechanisms described herein may be implemented by multiple instances of the system 1200 as well as by any other computing device, system, and/or environment. The system 1200 shown in FIG. 12 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1200 may include one or more processors 1202 and system memory 1204 communicatively coupled to the processor(s) 1202. The processor(s) 1202 may execute one or more modules and/or processes to cause the processor(s) 1202 to perform a variety of functions. In some embodiments, the processor(s) 1202 may include a central processing unit (“CPU”), a graphics processing unit (“GPU”), both CPU and GPU, or other processing units or components known in the art. Additionally, each of the processor(s) 1202 may possess its own local memory, which also may store program modules, program data, and/or one or more operating systems.

Depending on the exact configuration and type of the system 1200, the system memory 1204 may be volatile, such as RAM, non-volatile, such as ROM, flash memory, miniature hard drive, memory card, and the like, or some combination thereof. The system memory 1204 may include one or more computer-executable modules 1206 that are executable by the processor(s) 1202.

The modules 1206 may include, but are not limited to, one or more of an encoder 1208 and a decoder 1210.

The encoder 1208 may be a VVC and later standard encoder or AVS3 and later-standard encoder implementing any, some, or all aspects of example embodiments of the present disclosure as described above, and executable by the processor(s) 1202 to configure the processor(s) 1202 to perform operations as described above.

The decoder 1210 may be a VVC and later standard encoder or AVS3 and later-standard decoder implementing any, some, or all aspects of example embodiments of the present disclosure as described above, executable by the processor(s) 1202 to configure the processor(s) 1202 to perform operations as described above.

The system 1200 may additionally include an input/output (“I/O”) interface 1240 for receiving image source data and bitstream data, and for outputting reconstructed pictures into a reference picture buffer or DPB and/or a display buffer. The system 1200 may also include a communication module 1250 allowing the system 1200 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1230, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-8. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system to encode a video sequence to a bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
deriving a motion vector of a subblock by motion compensation prediction;
deriving a new chained motion vector predictor (“CMVP”) candidate based on the motion vector of the subblock;
inserting the new CMVP candidate into a merge list; and
encoding a coded picture comprising the subblock in a bitstream.

2. The computing system of claim 1, wherein the motion compensation prediction comprises affine transformation motion compensation prediction according to affine merge mode or affine Advanced Motion Vector Prediction (“AMVP”) mode.

3. The computing system of claim 1, wherein the new CMVP candidate comprises an accumulation of a first motion vector of a neighboring block, the first motion vector pointing to a top neighboring block of a first reference picture, and a second motion vector of the top neighboring block, the second motion vector pointing to a second reference picture.

4. The computing system of claim 1, wherein the new CMVP candidate comprises an accumulation of a scaled motion vector scaled from a first motion vector, the scaled motion vector pointing to a top neighboring block of a target reference picture, and a second motion vector of the top neighboring block of the target reference picture, the second motion vector pointing to a second reference picture.

5. The computing system of claim 4, wherein the first motion vector comprises one of a neighboring motion vector prediction (“MVP”) candidate; a temporal motion vector prediction (“TMVP”) candidate; a non-adjacent MVP candidate; and a history motion vector prediction (“HMVP”) candidate.

6. The computing system of claim 5, wherein inserting the new CMVP candidate into a merge list comprises inserting more than one of a neighboring MVP candidate; a TMVP candidate; a non-adjacent MVP candidate; and an HMVP candidate.

7. The computing system of claim 1, wherein the motion vector of the subblock comprises an affine CMVP of an affine list; and
the new CMVP candidate comprises an accumulation of a motion vector offset and the affine CMVP.

8. The computing system of claim 7, wherein inserting the new CMVP candidate into a merge list comprises inserting the new CMVP candidate after inherited affine candidates and before constructed affine candidates.

9. The computing system of claim 7, wherein inserting the new CMVP candidate into a merge list comprises inserting the new CMVP candidate after constructed affine candidates.

10. The computing system of claim 1, wherein the motion vector of the subblock comprises a top-left, top-right, or bottom-left neighboring motion vector, and the new CMVP candidate comprises a constructed affine candidate.

11. The computing system of claim 1, wherein the motion vector of the subblock comprises a top-left, top-right, or bottom-left non-adjacent motion vector, and the new CMVP candidate comprises a constructed non-adjacent affine candidate.

12. The computing system of claim 1, wherein the motion vector of the subblock is derived from a collocated picture according to subblock-based temporal motion vector prediction (“SbTMVP”).

13. The computing system of claim 1, wherein the new CMVP candidate comprises an accumulation of a first motion shift of a neighboring block pointing to a collocated block, and a second motion shift of a collocated block pointing to a first reference picture.

14. The computing system of claim 1, wherein the new CMVP candidate comprises a first motion shift of a neighboring block.

15. A computing system to decode a video sequence from a bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
deriving a motion vector of a subblock by motion compensation prediction;
deriving a new chained motion vector predictor (“CMVP”) candidate based on the motion vector of the subblock; and
inserting the new CMVP candidate into a merge list.

16. A method of storing a bitstream associated with a video sequence, the method comprising:
generating a bitstream comprising:
a size of a subblock-based merge list comprising one or more CMVP candidates derived based on a motion vector of a subblock derived by motion compensation prediction; and
storing the bitstream in a non-transitory computer-readable storage medium.

17. The method of claim 16, wherein the motion compensation prediction comprises affine transformation motion compensation prediction according to affine merge mode or affine Advanced Motion Vector Prediction (“AMVP”) mode.

18. The method of claim 16, wherein the motion vector of the subblock comprises one of a neighboring motion vector prediction (“MVP”) candidate; a temporal motion vector prediction (“TMVP”) candidate; a non-adjacent MVP candidate; and a history motion vector prediction (“HMVP”) candidate.

19. The method of claim 16, wherein the motion vector of the subblock comprises an affine CMVP of an affine list; and
the CMVP candidate comprises an accumulation of a motion vector offset and the affine CMVP.

20. The method of claim 16, wherein the motion vector of the subblock is derived from a collocated picture according to subblock-based temporal motion vector prediction (“SbTMVP”).
